(19) United States
(12) Patent Application Publication
(10) Pub. No.: US 2004/0191398 A1
(43) Pub. Date: Sep. 30, 2004

(54) Frozen surimi

(76) Inventors: Tsuneji Yamamoto, Tokyo (JP); Shohei Nozaki, Niigata-City (JP); Shugo Watabe, Hachioji-City (JP)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/653,253

(22) Filed: Sep. 3, 2003

(30) Foreign Application Priority Data
Mar. 31, 2003 (JP) P2003-93870
Jul. 2, 2003 (JP) P2003-190050

(51) Int. Cl. A23L 1/325

(52) U.S. Cl. 426/643

(57) ABSTRACT

This invention relates to frozen surimi to be used as a basic ingredient of kamaboko (boiled or steamed salt-added surimi), chikuwa (grilled salt-added surimi shaped like a section of bamboo), and fish sausages, etc., which containing (1) 0.05˜0.3% by weight of at least one kind selected among basic amino acids as food additives and (2) 0.05˜0.3% by weight of at least one kind selected among carbonates and (3) at least one kind selected among saccharides, and provides frozen surimi which is phosphorus-free, improved in quality without using polyphosphates that have been conventionally used as additives, and has frozen storage stability and a salt-grinding property equivalent to those in a case using polyphosphates, and furthermore has quality higher than conventional frozen surimi.

### BACKGROUND OF THE INVENTION

This invention relates to frozen surimi to be used as a basic ingredient of kamaboko (boiled or steamed salt-added surimi), chikuwa (grilled salt-added surimi shaped like a section of bamboo), and fish sausages, etc., and more specifically, frozen surimi which is improved in quality without using polyphosphates as additives.

Now, several technical terms used in this specification are explained as follows.

“Refined fish meat” is meaning of material made of fish through process of filleting and water bleaching to remove inorganic substances and water-soluble protein, and dehydrating.

“Surimi” is meaning of material made of refined fish meat through adding process of additives for cryo-preservation excluding salt, therefore, fibers in muscular tissue such as myosin and actin are not destroyed by salt. And, it is characteristic point that grinding process is not done in producing surimi, compared with following “Kara-Surimi” or “salt-added ground Surimi”.

“Frozen surimi” is meaning of material made of surimi through freezing process.

“Salt surimi” or “salt-added ground surimi” is meaning of material made of refined fish meat or melted frozen surimi through grinding process with salt. These “salt surimi” or “salt-added ground surimi” are the same as “fish paste”. Compared with “surimi”, “frozen surimi” and “kara-surimi”, a part of fibers in muscular tissue such as myosin and actin are solved by salt and transformed in the shape.

“Phosphorus-free surimi” is meaning of material made of the refined fish meat with saccharides, and containing no polyphosphates.

“Phosphorus containg surimi” is meaning of material made of the refined fish meat with phosphorus.

Frozen surimi to be used as a basic ingredient for producing various fish cakes was invented by NISHITANI Kyosuke, et al., at the Hokkaido Fisheries Experimental Station in 1960, making it practicable that fish meat could be prevented from spoiling as a result of being frozen by mixing the fish meat, obtained by immersing filleted meat of walleye pollack and dehydrating it, with saccharides and polyphosphates before freezing. This is an innovative technique within the marine products industry. 400-thousand tons of frozen surimi are produced per year in Japan, the USA, Russia, Thailand and from countries around the world at present. Frozen surimi is obtained by freezing only refined fish meat, so that it has various advantageous such that storage and transportation of such basic ingredients before being processed into various fish cakes are convenient, processes of raw fish cooking and water immersion requiring manpower can be eliminated, and the basic ingredient with stable quality can be acquired and stored consistently throughout the year.

However, in order to prevent such frozen surimi from spoiling as a result of being frozen, it is normally mixed with 5% by weight of saccharides and 0.2 to 0.3% by weight of polyphosphates. When a fish cake produced by using this frozen surimi as a basic ingredient is ingested into the body, polyphosphates contained in additives are accumulated inside the body for long periods of time, so that use of such phosphorus-containing ingredients as food additives cannot be said as being preferable even when their amounts are slight.

In some recent cases, in consideration of the abovementioned problem, salt-added fish paste is used as a basic ingredient of fish cake without using polyphosphates. However, the frozen storage period of this salt-added fish paste as a basic ingredient before being processed into a fish cake is about 120 days, and it may deteriorate in quality.

However, generally, in most cases where frozen surimi cannot be stored while being frozen for half a year through a year, or more long period in a factory producing various fish cakes, problems occur in the production of fish cakes. Therefore, fish paste of which the frozen storage period is short as in the case of the abovementioned salt-added fish paste is not an appropriate solution in view of production efficiency.

On the other hand, a case where phosphorus-free surimi (containing no polyphosphates, the same term also referred to below) containing only saccharides is used as a basic ingredient increases. A method for measuring Ca-ATPase activity of myofibril and actomyosin as an index of freezing denaturation of fish meat protein is employed, however, Ca-ATPase activity of myofibril of phosphorus-free surimi is almost the same as that of the abovementioned phosphorus-containing surimi (containing polyphosphates, the same term also referred to below). However, when salt-grinding the phosphorus-free surimi by adding salt, the phosphorus-free fish shows disadvantages such that it hardly becomes sticky, easily becomes lumpy, and the amount of hydration is small, and further causes problems in that the elasticity of the heated gel of the phosphorus-free surimi is smaller than in the case of phosphorus-containing fish paste.

Phosphorus-free surimi added with yolk-containing food additives with a high sugar content is disclosed in Japanese Examined Patent Publication No. H01-54026, however, this has no advantages in practicability.

Japan Patent No.2777611 teaches method for manufacturing fish cakes from no water bleaching fish meat characterized comprising pre-process to add alkali agents and saccharides to ground fish meat having 0.2˜5 mm in diameter, freezing and melting process, and process making small particles from the ground fish meat by adding aqueous solution of chlorides such as sodium chloride. This prior art discloses that no water bleaching fish meat is useable, and phosphorus or not phosphorus alkali agents can be used alternatively, however, do not disclose frozen surimi which can be stored over one year. Moreover, this prior art discloses about adding lysine and arginine, but these additives are used for reinforcing elasticity, and not used for long period preservation.

### SUMMARY OF THE INVENTION

To solve the abovementioned problems in prior arts, an object of the invention is, therefore, to provide phosphorus-free frozen surimi which has frozen storage stability and a salt-grinding property equivalent to those in a case using polyphosphates, and furthermore has quality higher than conventional frozen surimi without using food additives such as polyphosphates which could possibly result in complaints from consumer groups.

This invention for achieving the abovementioned object has the following compositions.

(A) Frozen surimi made from refined fish meat subjected to water immersion and dehydration, containing (1)0.05%˜0.3% by weight of at least one kind selected among basic amino acids as food additives, (2) 0.05%˜0.3% by weight of at least one kind selected among carbonates, and (3) at least one kind selected among saccharides.

(B) The frozen surimi according to the above (A), wherein the content of saccharides is in a range between 5%˜10% by weight.

(C) The frozen surimi according to the above (A), wherein each of the content of basic amino acids and carbonates is in a range between 0.1%˜0.2% by weight, and the content of saccharides is in a range between 5%˜8% by weight.

(D) The frozen surimi according to any one of the above (A) through (C), wherein the basic amino acids are at least one selected among arginine, arginine hydrochloride base, lysine, and lysine hydrochloride base.

(E) The frozen surimi according to any one of the above (A) through (D), wherein the carbonates are at least one selected among sodium carbonate, potassium carbonate, calcium carbonate and sodium bicarbonate.

In this invention, basic amino acids and carbonates added as well as saccharides are evenly dispersed in myofibril of refined fish meat that has been subjected to water immersion and dehydration, and are slightly bonded with myosin and actin to prevent them from being denaturated by freezing.

In this invention, basic amino acids and carbonates added as well as saccharides as additives are required to use together, and this combined use can be obtained excellent effects compared with a case of separated use. Next, during deflocculation in a salt-grinding process in which frozen surimi is thawed and added with salt, lustrous and sticky salt-ground fish paste is prepared by being greatly hydrated.

Furthermore, this process promotes setting and strengthens the meshed structure obtained by heating. When no saccharides are contained, these effects are not obtained at all since freezing denaturation is great, and when only saccharides are contained, these effects are also hardly obtained. And, in the invention, combined use of (1) at least one kind selected among basic amino acids and carbonates as food additives and (2) at least one kind selected among saccharides provides a synergistic effect.

### DETAILED DESCRIPTION OF PREFERRED EMBODIMENT

Hereinafter, the invention is described in detail.

Frozen surimi of the present invention is characterized by containing (1) at least one kind selected among basic amino acids as food additives, (2) at least one kind selected among carbonates, and (3) at least one kind selected among saccharides. In this invention, at least three agents selected from each of the three groups are required to use together, therefore, the object of the invention is not achieved by containing either (1) at least one kind selected among basic amino acids and carbonates as food additives or (2) at least one kind selected among saccharides.

First, following two agents are described, namely (1) at least one kind selected among basic amino acids as food additives and (2) at least one kind selected among carbonates.

As means for solving the abovementioned conventional problems and achieving the object, the invention has a first characteristic in that refined fish meat that has been subjected to water immersion and dehydration is mixed with each of 0.05 to 0.3% by weight of (1) at least one kind selected among basic amino acids and (2) at least one kind selected among carbonates.

The effects of freezing denaturation prevention derived from conventionally used polyphosphates, reported as technical information are:

1) maintaining a neutral pH of surimi,

2) regulation of ionic strength

3) chelate effect of ions

4) improvement in water retention

The inventors of the present invention found that in a case where phosphorus-containing surimi added with polyphosphates is salt-ground, salt-ground surimi becomes sticky and lustrous although phosphorus-free surimi after being salt-ground is excessively flocculated and insufficiently sticky, furthermore, polyphosphates have excellent hydration, promote setting, and have an elasticity increasing effect on heated gel.

Focusing on these points, the inventors of this invention earnestly studied various food additives, and as a result, found that combined use of (1) at least one kind selected among basic amino acids and (2) at least one kind selected among carbonates has effects similar to those of polyphosphates on frozen surimi.

Polyphosphates added to refined fish meat are evenly dispersed in myofibril, and are gradually bonded with myosin and actin during flocculation reaction of protein when being frozen. This bonding proceeds in the same manner in both cases of phosphorus-containing surimi and phosphorus-free surimi. When frozen surimi is thawed and salt-ground by adding salt, in the case of phosphorus-containing surimi, the salting-in effect derived from the polyphosphates increases and elasticity of the heated gel is increased by a setting promotion effect. On the other hand, phosphorus-free surimi easily flocculates and its salting-in effect is smaller, so that elasticity of the heated gel thereof is low.

As means for solving the abovementioned conventional problems and achieving the object, the invention has a second characteristic in that 5 to 10% by weight of the saccharides is mixed with refined fish meat that has been subjected to water immersion and dehydration.

As mentioned above, frozen surimi according to the present invention, which is mixed with saccharides together with basic amino acids and carbonates, has frozen storage stability equivalent to that of phosphorus-containing surimi added with polyphosphates, and processed into excellent salt-ground surimi being sufficiently sticky, whereby the elasticity of the heated gel becomes extremely excellent in comparison with the heated gel of phosphorus-containing surimi.

The kinds of fish to be used as refined fish meat in the invention include various kinds of fish that have been conventionally used for frozen surimi, and for example, walleye pollack, golden threadfin bream, white croaker, Atka mackerel, minamidara, pacific whiting, lizardfish, alfonsin, pike conger, sardine, and horse mackerel, etc., can be used, and among these, minamidara and golden threadfin bream are preferable.

Basic amino acids and carbonates used in the present invention include many varieties of generally-known basic amino acids and carbonates as food additives. As basic amino acids, for example, arginine, arginine hydrochloride, lysine, and lysine hydrochloride, etc., are used, and among these, arginine and lysine are preferable. As carbonates, for example, sodium carbonate, potassium carbonate, calcium carbonate and sodium bicarbonate, etc., are used, and among these, sodium bicarbonate and calcium carbonate are preferable.

Saccharides used in the invention include many varieties of saccharides and sugar alcohol as food additives. For example, as saccharides used in the invention, monosaccharides, disaccharides, and products of amylolysis, etc., are used. As monosaccharides, any of tetrose, pentose, and hexose, etc., can be used, for example, erythritol, threose, xylose, arabinose, glucose, fructose, mannose, and galactose, etc. As disaccharides, for example, sucrose, lactose, and maltose can be used. Among these, trehalose, maltose, lactose, glucose, fructose, xylose, galactose, and sucrose are preferable. Furthermore, natural products such as starch syrup or honey containing saccharides and processed products can also be used. As sugar alcohol, for example, maltitol, Palatinit, lactol, erythritol, xylitol, mannitol, sorbitol, and products of reduced starch hydrolysis are used.

In this invention, next three agents should be used simultaneously, namely (1) at least one kind selected among basic amino acids and (2) at least one kind selected among carbonates, and (3) at least one kind selected among saccharides. And, for forth agents, for example organic chlorides such as citric acid, can be used excluding in a case the objects of the present invention are ruined.

### Embodiment 1

Refined fish meat with a moisture content of 78% by weight of a walleye pollack (hereinafter, referred to as walleye pollack's refined meat) was added with 4% by weight of sucrose, saccharine with a sorbitol content of 4% by weight, 0.1% by weight of arginine, and 0.1% by weight of bicarbonate of soda, and mixed in the same conditions as following Comparative Example 1 and frozen (Sample 1).

### Embodiment 2

Walleye pollack's refined meat was added with 4% by weight of sucrose, saccharine with a sorbitol content of 4% by weight, and 0.1% by weight of arginine and 0.1% by weight of potassium carbonate, and mixed in the same conditions as Comparative Example 1 and frozen (Sample 1).

### COMPARATIVE EXAMPLE 1

Walleye pollack's refined meat was prepared by immersing filleted meat of the walleye pollack in water to remove inorganic substances and water-soluble protein and dehydrating it, and was added with 4% by weight of sucrose, saccharine with a sorbitol content of 4% by weight, and 0.2% by weight of arginine, and thereafter, the walleye pollack's refined meat was stirred for 10 minutes at 13° C. and then frozen to −35° C. (Comparative Sample 1).

### COMPARATIVE EXAMPLE 2

Walleye pollack's refined meat was added with 4% by weight of sucrose, saccharine with a sorbitol content of 4% by weight, and 0.2% by weight of arginine hydrochloride, and mixed in the same conditions as Comparative Sample 1 and frozen (Comparative Sample 2).

### COMPARATIVE EXAMPLE 3

Walleye pollack's refined meat was added with 4% by weight of sucrose, saccharine with a sorbitol content of 4% by weight, and 0.2% by weight of lysine, and mixed in the same conditions as Comparative Sample 1 and frozen (Comparative Sample 3).

### COMPARATIVE EXAMPLE 4

Walleye pollack's refined meat was added with 4% by weight of sucrose, saccharine with a sorbitol content of 4% by weight, and 0.2% by weight of bicarbonate of soda, and mixed in the same conditions as Comparative Sample 1 and frozen (Comparative Sample 4).

### COMPARATIVE EXAMPLE 5

Walleye pollack's refined meat was added with 4% by weight of sucrose, saccharine with a sorbitol content of 4% by weight, and 0.2% by weight of potassium carbonate, and mixed in the same conditions as Comparative Sample 1 and frozen (Comparative Sample 5).

### COMPARATIVE EXAMPLE 6

Walleye pollack's refined meat was added with 4% by weight of sucrose, saccharine with a sorbitol content of 4% by weight, 0.1% by weight of arginine, and 0.1% by weight of lysine, and mixed in the same conditions as Comparative Sample 1 and frozen (Comparative Sample 6).

### COMPARATIVE EXEMPLE 7

Walleye pollack's refined meat was added with 4% by weight of sucrose, saccharine with a sorbitol content of 4% by weight, 0.1% by weight of bicarbonate of soda, and 0.1% by weight of potassium carbonate, and mixed in the same conditions as Comparative Sample 1 and frozen (Comparative Sample 7).

### COMPARATIVE EXAMPLE 8

Walleye pollack's refined meat was added with 4% by weight of sucrose, saccharine with a sorbitol content of 4% by weight, 0.2% by weight of polyphosphate, and mixed in the same conditions as Comparative Sample 1 and frozen (Comparative Sample 8).

The above Samples 1 and 2 and Comparative Samples 1 through 8 were put under frozen preservation, and the Samples saved for one month, six months, twelve months, and eighteen months were processed into the fish cakes. And, the breaking strength (g), depression (m/m), softness (%), and elasticity are measured for each of the fish cakes, the results of measurements are shown in Tables 1 through 4. The results for the fish cakes made of Samples saved for one month are shown in Table 1, the same, Table 2 shows for six months, Table 3 shows for twelve months and Table 4 shows for eighteen months.

The breaking strength (g) and depression (m/m) of the heated gel were measured with a rheometer made by Sun Kagaku Kikai Co., Ltd. by using a 5φplunger. The softness (%) is indicated as depression/breaking strength×100.

Elasticity evaluation is carried out on a scale on which 10 shows perfection. Namely, extremely high elasticity scores 10 points, very high elasticity scores 9 points, high elasticity scores 8 points, slightly high elasticity scores 7 points, normal elasticity scores 6 points, slightly low elasticity scores 5 points, low elasticity scores 4 points, very low elasticity scores 3 points, almost zero elasticity scores 2 points, and zero elasticity scores 1 point.

TABLE 1
Kamaboko Quality (Made from Samples saved for one month)

| | Breaking strength | Depression | Softness | Elasticity |
|---|---|---|---|---|
| No. | (g) | (m/m) | (%) | evaluation |
| Comparative | 540 | 14.1 | 0.26 | 7.1 |
| Example 1 | | | | |
| Comparative | 502 | 14.1 | 0.28 | 6.7 |
| Example 2 | | | | |
| Comparative | 526 | 14.2 | 0.26 | 7.1 |
| Example 3 | | | | |
| Comparative | 562 | 13.5 | 0.24 | 7.1 |
| Example 4 | | | | |
| Comparative | 564 | 13.1 | 0.23 | 7.1 |
| Example 5 | | | | |
| Comparative | 542 | 14.7 | 0.26 | 7.1 |
| Example 6 | | | | |
| Comparative | 568 | 14.3 | 0.24 | 7.1 |
| Example 7 | | | | |
| Comparative | 406 | 12.2 | 0.31 | 6.1 |
| Example 8 | | | | |
| Embodiment 1 | 570 | 12.2 | 0.25 | 7.1 |
| Embodiment 2 | 575 | 14.2 | 0.25 | 7.1 |

TABLE 2
Kamaboko Quality (Made from Samples saved for six months)

| | Breaking strength | Depression | Softness | Elasticity |
|---|---|---|---|---|
| No. | (g) | (m/m) | (%) | evaluation |
| Comparative | 545 | 14.2 | 0.26 | 7.1 |
| Example 1 | | | | |
| Comparative | 408 | 12.6 | 0.31 | 6.2 |
| Example 2 | | | | |
| Comparative | 532 | 13.8 | 0.26 | 7.1 |
| Example 3 | | | | |
| Comparative | 545 | 13.1 | 0.24 | 7.1 |
| Example 4 | | | | |
| Comparative | 554 | 13.3 | 0.24 | 7.1 |
| Example 5 | | | | |
| Comparative | 545 | 14.2 | 0.26 | 7.1 |
| Example 6 | | | | |
| Comparative | 568 | 13.4 | 0.24 | 7.1 |
| Example 7 | | | | |
| Comparative | 395 | 12.2 | 0.31 | 6.1 |
| Example 8 | | | | |
| Embodiment 1 | 572 | 14.3 | 0.25 | 7.1 |
| Embodiment 2 | 570 | 14.3 | 0.25 | 7.1 |

TABLE 3
Kamaboko Quality (Made from Samples saved for twelve months)

| | Breaking strength | Depression | Softness | Elasticity |
|---|---|---|---|---|
| No. | (g) | (m/m) | (%) | evaluation |
| Comparative | 540 | 14.0 | 0.26 | 6.9 |
| Example 1 | | | | |
| Comparative | 368 | 12.1 | 0.33 | 5.8 |
| Example 2 | | | | |
| Comparative | 542 | 14.1 | 0.26 | 6.9 |
| Example 3 | | | | |
| Comparative | 540 | 13.2 | 0.24 | 6.9 |
| Example 4 | | | | |
| Comparative | 545 | 13.3 | 0.24 | 6.9 |
| Example 5 | | | | |
| Comparative | 543 | 14.1 | 0.26 | 6.9 |
| Example 6 | | | | |
| Comparative | 531 | 13.3 | 0.25 | 6.9 |
| Example 7 | | | | |
| Comparative | 393 | 12.2 | 0.31 | 5.9 |
| Example 8 | | | | |
| Embodiment 1 | 566 | 14.2 | 0.25 | 7.1 |
| Embodiment 2 | 568 | 14.2 | 0.25 | 7.1 |

TABLE 4
Kamaboko Quality (Made from Samples saved for eighteen months)

| | Breaking strength | Depression | Softness | Elasticity |
|---|---|---|---|---|
| No. | (g) | (m/m) | (%) | evaluation |
| Comparative | 520 | 13.9 | 0.27 | 6.8 |
| Example 1 | | | | |
| Comparative | 355 | 11.8 | 0.33 | 5.5 |
| Example 2 | | | | |
| Comparative | 505 | 14.1 | 0.28 | 6.8 |
| Example 3 | | | | |
| Comparative | 502 | 13.2 | 0.26 | 6.6 |
| Example 4 | | | | |
| Comparative | 507 | 13.3 | 0.26 | 6.6 |
| Example 5 | | | | |
| Comparative | 528 | 14.1 | 0.27 | 6.8 |
| Example 6 | | | | |
| Comparative | 518 | 13.3 | 0.26 | 6.6 |
| Example 7 | | | | |
| Comparative | 370 | 12.2 | 0.33 | 5.7 |
| Example 8 | | | | |
| Embodiment 1 | 560 | 14.2 | 0.25 | 7.1 |
| Embodiment 2 | 568 | 14.2 | 0.25 | 7.1 |

From Table 1, regarding the frozen surimi (Embodiments 1 and 2) of the present invention obtained by adding saccharide, basic amino acid, and carbonate to walleye pollack's refined meat, in comparison with frozen surimi (Comparative example 8) added with polyphosphate, the breaking strength was higher, depression was greater, softness was proper at 0.25 or less, and furthermore, elasticity evaluation was higher, and as a whole, these embodiments were excellent in all aspects. The frozen surimi ( Comparative examples 1 through 7) obtained by adding saccharide and eighter one of basic amino acid or carbonate, in cases of frozen preservation of one month, six months and twelve months, these have results as near as the present invention, however in cases of frozen preservation of eighteen months, these have not the same results as the present invention (see Tables 1 through 4).

When the same experiment was also conducted for Atka mackerel's refined meat, the same results as in Table 1 were obtained.

### Embodiments 3 through 6

### COMPARATIVE EXAMPLES 9 THROUGH 43

As shown in Table 5, many types of frozen surimi relating to the present invention and comparative frozen surimi, in which the amounts of additives were variously adjusted, were tested as an experiment. And after one month, six months, twelve months and eighteen months, samples of Kamaboko were processed according to ordinary method. Tables 6 through 9 show properties of salt-ground surimi and elasticity of heated kamaboko. A five-senses test (particularly, visual check and tactile sensation) was conducted for judgements of flocculation, stickiness, and lustrousness by 10 persons. On the other hand, elasticity of heated kamaboko was evaluated by judging hardness, tenderness, and firmness by a five-senses test by the same 10 persons on a scale of one to ten.

TABLE 5

| | Sugar | Basic | | Poly- |
|---|---|---|---|---|
| | (% by | amino acid | Carbonate | phosphate |
| No. | weight) | (% by weight) | (% by weight) | (% by weight) |
| Comparative | — | — | — | — |
| Example 9 | | | | |
| Comparative | 2 | — | — | — |
| Example 10 | | | | |
| Comparative | 4 | — | — | — |
| Example 11 | | | | |
| Comparative | 6 | — | — | — |
| Example 12 | | | | |
| Comparative | 10 | — | — | — |
| Example 13 | | | | |
| Comparative | 15 | | — | — |
| Example 14 | | | | |
| Comparative | 5 | 0.01 | — | — |
| Example 15 | | | | |
| Comparative | 5 | 0.05 | — | — |
| Example 16 | | | | |
| Comparative | 5 | 0.10 | — | — |
| Example 17 | | | | |
| Comparative | 5 | 0.20 | — | — |
| Example 18 | | | | |
| Comparative | 5 | 0.40 | — | — |
| Example 19 | | | | |
| Comparative | 5 | 0.60 | — | — |
| Example 20 | | | | |
| Comparative | 5 | — | 0.01 | — |
| Example 21 | | | | |
| Comparative | 5 | — | 0.05 | — |
| Example 22 | | | | |
| Comparative | 5 | — | 0.10 | — |
| Example 23 | | | | |
| Comparative | 5 | — | 0.20 | — |
| Example 24 | | | | |
| Comparative | 5 | — | 0.40 | — |
| Example 25 | | | | |
| Comparative | 5 | — | 0.60 | — |
| Example 26 | | | | |
| Comparative | 5 | — | — | 0.01 |
| Example 27 | | | | |
| Comparative | 5 | — | — | 0.05 |
| Example 28 | | | | |
| Comparative | 5 | — | — | 0.10 |
| Example 29 | | | | |
| Comparative | 5 | — | — | 0.20 |
| Example 30 | | | | |
| Comparative | 5 | — | — | 0.40 |
| Example 31 | | | | |
| Comparative | 5 | — | — | 0.60 |
| Example 32 | | | | |
| Comparative | — | — | — | 0.20 |
| Example 33 | | | | |
| Comparative | — | — | — | 0.40 |
| Example 34 | | | | |
| Comparative | — | — | — | 0.60 |
| Example 35 | | | | |
| Comparative | — | 0.20 | — | — |
| Example 36 | | | | |
| Comparative | — | 0.40 | — | — |
| Example 37 | | | | |
| Comparative | — | 0.60 | — | — |
| Example 38 | | | | |
| Comparative | — | — | 0.20 | — |
| Example 39 | | | | |
| Comparative | — | — | 0.40 | — |
| Example 40 | | | | |
| Comparative | — | — | 0.60 | — |
| Example 41 | | | | |
| Comparative | 5 | 0.005 | 0.005 | — |
| Example 42 | | | | |
| Comparative | 5 | 0.025 | 0.025 | — |
| example 43 | | | | |
| Embodiment | 5 | 0.05 | 0.05 | — |
| 3 | | | | |
| Embodiment | 5 | 0.10 | 0.10 | — |
| 4 | | | | |
| Embodiment | 5 | 0.20 | 0.20 | — |
| 5 | | | | |
| Embodiment | 5 | 0.30 | 0.30 | — |
| 6 | | | | |

TABLE 6

| | Properties of salt-ground fish paste | | | | Elasticity of kamaboko | | | | |
|---|---|---|---|---|---|---|---|---|---|
| | | | | Total | | | | Total | Overall |
| No. | flocculation | Stickiness | Lustrousness | score | Hardness | Tenderness | Firmness | score | score |
| Comparative | High | Non | Non | 1 | Non | Non | Non | 1 | 2 |
| Example 9 | | | | | | | | | |
| Comparative | High | Non | Non | 2 | Non | Non | Non | 2 | 4 |
| Example 10 | | | | | | | | | |
| Comparative | Slightly | Non | Non | 4 | Slightly | Non | Non | 4 | 8 |
| Example 11 | high | | | | hard | | | | |
| Comparative | Slightly | Non | Non | 5 | Hard | Non | Non | 5 | 10 |
| Example 12 | high | | | | | | | | |
| Comparative | Low | Sticky | Lustrous | 6 | Hard | Non | Non | 4 | 10 |
| Example 13 | | | | | | | | | |
| Comparative | Low | Sticky | Lustrous | 7 | Slightly | Non | Non | 3 | 10 |
| Example 14 | | | | | hard | | | | |
| Comparative | High | Non | Non | 5 | Slightly | Non | Non | 5 | 10 |
| Example 15 | | | | | hard | | | | |
| Comparative | High | Non | Non | 6 | Slightly | Slightly | Slightly | 6 | 12 |
| Example 16 | | | | | hard | tender | firm | | |
| Comparative | Slightly | Slightly | Slightly | 7 | Hard | Tender | Firm | 8 | 15 |
| Example 17 | low | sticky | lustrous | | | | | | |
| Comparative | Low | Sticky | Lustrous | 8 | Hard | Tender | Firm | 9 | 17 |
| Example 18 | | | | | | | | | |
| Comparative | Low | Sticky | Lustrous | 8 | Hard | Tender | Firm | 9 | 17 |
| Example 19 | | | | | | | | | |
| Comparative | Low | Sticky | Lustrous | 7 | Hard | Tender | Firm | 8 | 15 |
| Example 20 | | | | | | | | | |
| Comparative | High | Non | Non | 5 | Slightly | Non | Non | 5 | 10 |
| Example 21 | | | | | hard | | | | |
| Comparative | High | Non | Non | 6 | Slightly | Slightly | Slightly | 6 | 12 |
| Example 22 | | | | | hard | tender | firm | | |
| Comparative | Slightly | Sightly | Slightly | 7 | Hard | Tender | Firm | 7 | 14 |
| Example 23 | low | sticky | lustrous | | | | | | |
| Comparative | Low | Sticky | Lustrous | 8 | Hard | Tender | Firm | 8 | 16 |
| Example 24 | | | | | | | | | |
| Comparative | Low | Sticky | Lustrous | 8 | Hard | Tender | Firm | 8 | 16 |
| Example 25 | | | | | | | | | |
| Comparative | Low | Sticky | Lustrous | 7 | Hard | Tender | Firm | 7 | 14 |
| Example 26 | | | | | | | | | |
| Comparative | High | Non | Non | 5 | Slightly | Non | Non | 4 | 9 |
| Example 27 | | | | | hard | | | | |
| Comparative | Slightly | Non | Non | 6 | Slightly | Non | Non | 5 | 11 |
| Example 28 | high | | | | hard | | | | |
| Comparative | Low | Sticky | Lustrous | 8 | Hard | Slightly | Slightly | 6 | 14 |
| Example 29 | | | | | | tender | firm | | |
| Comparative | Low | Sticky | Lustrous | 9 | Hard | Slightly | Slightly | 6 | 15 |
| Example 30 | | | | | | tender | firm | | |
| Comparative | Low | Sticky | Lustrous | 9 | Hard | Tender | Firm | 7 | 16 |
| Example 31 | | | | | | | | | |
| Comparative | Low | Sticky | Lustrous | 8 | Hard | Slightly | Slightly | 6 | 14 |
| Example 32 | | | | | | tender | firm | | |
| Comparative | High | Non | Non | 1 | Non | Non | Non | 2 | 3 |
| Example 33 | | | | | | | | | |
| Comparative | High | Non | Non | 2 | Non | Non | Non | 2 | 4 |
| Example 34 | | | | | | | | | |
| Comparative | High | Non | Non | 2 | Non | Non | Non | 2 | 4 |
| Example 35 | | | | | | | | | |
| Comparative | High | Non | Non | 1 | Non | Non | Non | 2 | 3 |
| Example 36 | | | | | | | | | |
| Comparative | High | Non | Non | 2 | Non | Non | Non | 2 | 4 |
| Example 37 | | | | | | | | | |
| Comparative | High | Non | Non | 2 | Non | Non | Non | 2 | 4 |
| Example 38 | | | | | | | | | |
| Comparative | High | Non | Non | 1 | Non | Non | Non | 2 | 3 |
| Example 39 | | | | | | | | | |
| Comparative | High | Non | Non | 2 | Non | Non | Non | 2 | 4 |
| Example 40 | | | | | | | | | |
| Comparative | High | Non | Non | 2 | Non | Non | Non | 2 | 4 |
| Example 41 | | | | | | | | | |
| Comparative | High | Non | Non | 5 | Slightly | Non | Non | 5 | 10 |
| Example 42 | | | | | hard | | | | |
| Comparative | Slightly | Non | Non | 6 | Slightly | Slightly | Slightly | 6 | 12 |
| Example 43 | high | | | | hard | tender | firm | | |
| Embodiment 3 | Slightly | Slightly | Slightly | 7 | Hard | Tender | Firm | 8 | 15 |
| | low | sticky | lustrous | | | | | | |
| Embodiment 4 | Low | Sticky | Lustrous | 8 | Hard | Tender | Firm | 9 | 17 |
| Embodiment 5 | Low | Sticky | Lustrous | 8 | Hard | Tender | Firm | 9 | 17 |
| Embodiment 6 | Low | Sticky | Lustrous | 7 | Hard | Tender | Firm | 8 | 15 |

Tables 5 and 6 show the results of examination of the concentrations of additives in that prevention of freezing denaturation of myofibril protein by the addition of saccharide increases as the amount of addition increases, and a particularly desirable amount of addition of saccharide is 5 to 8% by weight since protein concentration relatively lowers and elasticity of the heated gel lowers in addition to an increase in sweetness if the amount of addition of saccharide is more 10% by weight. Although the addition of basic amino acids and carbonates is effective even when the amount of addition is 0.05% by weight, a particularly preferable amount of addition is 0.1 to 0.2% by weight since an excessive amount of addition of these increases alkalinity and this is not preferable.

TABLE 7

| | Properties of salt-ground fish paste | | | | Elasticity of kamaboko | | | | |
|---|---|---|---|---|---|---|---|---|---|
| | | | | Total | | | | Total | Overall |
| No. | flocculation | Stickiness | Lustrousness | score | Hardness | Tenderness | Firmness | score | score |
| Comparative | High | Non | Non | 0 | Non | Non | Non | 0 | 0 |
| Example 9 | | | | | | | | | |
| Comparative | High | Non | Non | 1 | Non | Non | Non | 0 | 1 |
| Example 10 | | | | | | | | | |
| Comparative | Slightly | Non | Non | 3 | Slightly | Non | Non | 3 | 6 |
| Example 11 | high | | | | hard | | | | |
| Comparative | Slightly | Non | Non | 5 | Hard | Non | Non | 5 | 10 |
| Example 12 | high | | | | | | | | |
| Comparative | Low | Sticky | Lustrous | 6 | Hard | Non | Non | 4 | 10 |
| Example 13 | | | | | | | | | |
| Comparative | Low | Sticky | Lustrous | 7 | Slightly | Non | Non | 3 | 10 |
| Example 14 | | | | | hard | | | | |
| Comparative | High | Non | Non | 5 | Slightly | Non | Non | 4 | 9 |
| Example 15 | | | | | hard | | | | |
| Comparative | High | Non | Non | 6 | Slightly | Slightly | Slightly | 6 | 12 |
| Example 16 | | | | | hard | tender | firm | | |
| Comparative | Slightly | Slightly | Slightly | 7 | Hard | Tender | Firm | 8 | 15 |
| example 17 | low | sticky | lustrous | | | | | | |
| Comparative | Low | Sticky | Lustrous | 8 | Hard | Tender | Firm | 9 | 17 |
| Example 18 | | | | | | | | | |
| Comparative | Low | Sticky | Lustrous | 8 | Hard | Tender | Firm | 9 | 17 |
| Example 19 | | | | | | | | | |
| Comparative | Low | Sticky | Lustrous | 7 | Hard | Tender | Firm | 8 | 15 |
| Example 20 | | | | | | | | | |
| Comparative | High | Non | Non | 5 | Slightly | Non | Non | 4 | 9 |
| Example 21 | | | | | hard | | | | |
| Comparative | High | Non | Non | 6 | Slightly | Slightly | Slightly | 6 | 12 |
| Example 22 | | | | | hard | tender | firm | | |
| Comparative | Slightly | Slightly | Slightly | 7 | Hard | Tender | Firm | 7 | 14 |
| Example 23 | low | sticky | lustrous | | | | | | |
| Comparative | Low | Sticky | Lustrous | 8 | Hard | Tender | Firm | 8 | 16 |
| Example 24 | | | | | | | | | |
| Comparative | Low | Sticky | Lustrous | 8 | Hard | Tender | Firm | 8 | 16 |
| Example 25 | | | | | | | | | |
| Comparative | Low | Sticky | Lustrous | 7 | Hard | Tender | Firm | 7 | 14 |
| Example 26 | | | | | | | | | |
| Comparative | High | Non | Non | 4 | Slightly | Non | Non | 3 | 7 |
| Example 27 | | | | | hard | | | | |
| Comparative | Slightly | Non | Non | 5 | Slightly | Non | Non | 4 | 9 |
| example 28 | high | | | | hard | | | | |
| Comparative | Low | Sticky | Lustrous | 8 | Hard | Slightly | Slightly | 6 | 14 |
| Example 29 | | | | | | tender | firm | | |
| Comparative | Low | Sticky | Lustrous | 9 | Hard | Slightly | Slightly | 6 | 15 |
| Example 30 | | | | | | tender | firm | | |
| Comparative | Low | Sticky | Lustrous | 9 | Hard | Tender | Firm | 7 | 16 |
| Example 31 | | | | | | | | | |
| Comparative | Low | Sticky | Lustrous | 8 | Hard | Slightly | Slightly | 6 | 14 |
| Example 32 | | | | | | tender | firm | | |
| Comparative | High | Non | Non | 0 | Non | Non | Non | 0 | 0 |
| Example 33 | | | | | | | | | |
| Comparative | High | Non | Non | 0 | Non | Non | Non | 0 | 0 |
| Example 34 | | | | | | | | | |
| Comparative | High | Non | Non | 1 | Non | Non | Non | 1 | 2 |
| Example 35 | | | | | | | | | |
| Comparative | High | Non | Non | 0 | Non | Non | Non | 0 | 0 |
| Example 36 | | | | | | | | | |
| Comparative | High | Non | Non | 0 | Non | Non | Non | 0 | 0 |
| Example 37 | | | | | | | | | |
| Comparative | High | Non | Non | 1 | Non | Non | Non | 1 | 2 |
| Example 38 | | | | | | | | | |
| Comparative | High | Non | Non | 0 | Non | Non | Non | 0 | 0 |
| Example 39 | | | | | | | | | |
| Comparative | High | Non | Non | 0 | Non | Non | Non | 0 | 0 |
| Example 40 | | | | | | | | | |
| Comparative | High | Non | Non | 1 | Non | Non | Non | 1 | 2 |
| Example 41 | | | | | | | | | |
| Comparative | High | Non | Non | 5 | Slightly | Non | Non | 4 | 9 |
| Example 42 | | | | | hard | | | | |
| Comparative | Slightly | Non | Non | 6 | Slightly | Slightly | Slightly | 6 | 12 |
| Example 43 | high | | | | hard | tender | firm | | |
| Embodiment 3 | Slightly | Slightly | Slightly | 7 | Hard | Tender | Firm | 8 | 15 |
| | high | sticky | lustrous | | | | | | |
| Embodiment 4 | Low | Sticky | Lustrous | 8 | Hard | Tender | Firm | 9 | 17 |
| Embodiment 5 | Low | Sticky | Lustrous | 8 | Hard | Tender | Firm | 9 | 17 |
| Embodiment 6 | Low | Sticky | Lustrous | 7 | Hard | Tender | Firm | 8 | 15 |

TABLE 8

| | Properties of salt-ground fish paste | | | | Elasticity of kamaboko | | | | |
|---|---|---|---|---|---|---|---|---|---|
| | | | | Total | | | | Total | Overall |
| No. | flocculation | Stickiness | Lustrousness | score | Hardness | Tenderness | Firmness | score | score |
| Comparative | High | Non | Non | 0 | Non | Non | Non | 0 | 0 |
| Example 9 | | | | | | | | | |
| Comparative | High | Non | Non | 0 | Non | Non | Non | 0 | 0 |
| Example 10 | | | | | | | | | |
| Comparative | High | Non | Non | 1 | Non | Non | Non | 2 | 3 |
| Example 11 | | | | | | | | | |
| Comparative | High | Non | Non | 2 | Slightly | Non | Non | 3 | 5 |
| Example 12 | | | | | hard | | | | |
| Comparative | Slightly | Sticky | Lustrous | 3 | Slightly | Non | Non | 4 | 7 |
| Example 13 | high | | | | hard | | | | |
| Comparative | Slightly | Sticky | Lustrous | 4 | Slightly | Non | Non | 3 | 7 |
| Example 14 | high | | | | hard | | | | |
| Comparative | High | Non | Non | 3 | Non | Non | Non | 3 | 6 |
| Example 15 | | | | | | | | | |
| Comparative | High | Non | Non | 6 | Slightly | Slightly | Slightly | 5 | 11 |
| Example 16 | | | | | hard | tender | firm | | |
| Comparative | High | Slightly | Slightly | 7 | Slightly | Slightly | Slightly | 7 | 14 |
| Example 17 | | sticky | lustrous | | hard | tender | Firm | | |
| Comparative | Slightly | Slightly | Slightly | 8 | Hard | Tender | Firm | 8 | 16 |
| Example 18 | high | Sticky | Lustrous | | | | | | |
| Comparative | Low | Sticky | Lustrous | 8 | Hard | Tender | Firm | 8 | 16 |
| Example 19 | | | | | | | | | |
| Comparative | Low | Sticky | Lustrous | 7 | Hard | Tender | Firm | 7 | 14 |
| Example 20 | | | | | | | | | |
| Comparative | High | Non | Non | 3 | Non | Non | Non | 3 | 6 |
| Example 21 | | | | | | | | | |
| Comparative | High | Non | Non | 6 | Slightly | Slightly | Non | 5 | 11 |
| Example 22 | | | | | hard | tender | | | |
| Comparative | High | Non | Non | 6 | Slightly | Slightly | Slightly | 6 | 12 |
| Example 23 | | | | | hard | tender | firm | | |
| Comparative | Slightly | Slightly | Slightly | 8 | Hard | Tender | Slightly | 7 | 15 |
| Example 24 | high | Sticky | Lustrous | | | | firm | | |
| Comparative | Slightly | Slightly | Slightly | 8 | Hard | Tender | Firm | 7 | 15 |
| Example 25 | high | Sticky | Lustrous | | | | | | |
| Comparative | Slightly | Sticky | Lustrous | 7 | Hard | Tender | Firm | 6 | 13 |
| Example 26 | high | | | | | | | | |
| Comparative | High | Non | Non | 3 | Non | Non | Non | 3 | 6 |
| Example 27 | | | | | | | | | |
| Comparative | High | Sticky | Non | 5 | Slightly | Non | Non | 3 | 8 |
| Example 28 | | | | | hard | | | | |
| Comparative | Slightly | Sticky | Lustrous | 8 | Hard | Non | Non | 5 | 13 |
| Example 29 | high | | | | | | | | |
| Comparative | Low | Sticky | Lustrous | 9 | Hard | Slightly | Slightly | 6 | 15 |
| Example 30 | | | | | | tender | firm | | |
| Comparative | Low | Sticky | Lustrous | 9 | Hard | Slightly | Slightly | 6 | 15 |
| Example 31 | | | | | | tender | firm | | |
| Comparative | Low | Sticky | Lustrous | 8 | Hard | Slightly | Slightly | 6 | 14 |
| Example 32 | | | | | | tender | firm | | |
| Comparative | High | Non | Non | 0 | Non | Non | Non | 0 | 0 |
| Example 33 | | | | | | | | | |
| Comparative | High | Non | Non | 1 | Non | Non | Non | 1 | 2 |
| Example 34 | | | | | | | | | |
| Comparative | High | Non | Non | 1 | Non | Non | Non | 1 | 2 |
| Example 35 | | | | | | | | | |
| Comparative | High | Non | Non | 0 | Non | Non | Non | 0 | 0 |
| Example 36 | | | | | | | | | |
| Comparative | High | Non | Non | 1 | Non | Non | Non | 1 | 2 |
| Example 37 | | | | | | | | | |
| Comparative | High | Non | Non | 1 | Non | Non | Non | 1 | 2 |
| Example 38 | | | | | | | | | |
| Comparative | High | Non | Non | 0 | Non | Non | Non | 0 | 0 |
| Example 39 | | | | | | | | | |
| Comparative | High | Non | Non | 1 | Non | Non | Non | 1 | 2 |
| Example 40 | | | | | | | | | |
| Comparative | High | Non | Non | 1 | Non | Non | Non | 1 | 2 |
| example 41 | | | | | | | | | |
| Comparative | High | Non | Non | 4 | Slightly | Non | Non | 4 | 8 |
| Example 42 | | | | | hard | | | | |
| Comparative | High | Non | Non | 6 | Slightly | Slightly | Slightly | 6 | 12 |
| Example 43 | | | | | hard | tender | firm | | |
| Embodiment 3 | High | Slightly | Slightly | 7 | Hard | Tender | Firm | 8 | 15 |
| | | sticky | lustrous | | | | | | |
| Embodiment 4 | Slightly | Slightly | Slightly | 8 | Hard | Tender | Firm | 9 | 17 |
| | high | sticky | lustrous | | | | | | |
| Embodiment 5 | Slightly | Sticky | Lustrous | 8 | Hard | Tender | Firm | 9 | 17 |
| | high | | | | | | | | |
| Embodiment 6 | Slightly | Sticky | Lustrous | 7 | Hard | Tender | Firm | 8 | 15 |
| | high | | | | | | | | |

TABLE 9

| | Properties of salt-ground fish paste | | | | Elasticity of kamaboko | | | | |
|---|---|---|---|---|---|---|---|---|---|
| | | | | Total | | | | Total | Overall |
| No. | flocculation | Stickiness | Lustrousness | score | Hardness | Tenderness | Firmness | score | score |
| Comparative | High | Non | Non | 0 | Non | Non | Non | 0 | 0 |
| Example 9 | | | | | | | | | |
| Comparative | High | Non | Non | 0 | Non | Non | Non | 0 | 0 |
| Example 10 | | | | | | | | | |
| Comparative | High | Non | Non | 1 | Non | Non | Non | 1 | 2 |
| Example 11 | | | | | | | | | |
| Comparative | High | Non | Non | 2 | Slightly | Non | Non | 2 | 4 |
| Example 12 | | | | | hard | | | | |
| Comparative | Slightly | Sticky | Lustrous | 3 | Slightly | Non | Non | 3 | 6 |
| Example 13 | high | | | | hard | | | | |
| Comparative | Slightly | Sticky | Lustrous | 4 | Slightly | Non | Non | 3 | 7 |
| Example 14 | high | | | | hard | | | | |
| Comparative | High | Non | Non | 2 | Non | Non | Non | 2 | 4 |
| Example 15 | | | | | | | | | |
| Comparative | High | Non | Non | 5 | Slightly | Non | Non | 4 | 9 |
| Example 16 | | | | | hard | | | | |
| Comparative | High | Slightly | Slightly | 6 | Slightly | Slightly | Slightly | 6 | 12 |
| Example 17 | | sticky | lustrous | | hard | tender | firm | | |
| Comparative | Slightly | Slightly | Slightly | 7 | Hard | Slightly | Slightly | 7 | 14 |
| Example 18 | high | sticky | lustrous | | | tender | firm | | |
| Comparative | Slightly | Sticky | Lustrous | 7 | Hard | Tender | Firm | 7 | 14 |
| Example 19 | high | | | | | | | | |
| Comparative | Slightly | Sticky | Lustrous | 7 | Hard | Tender | Firm | 7 | 14 |
| Example 20 | high | | | | | | | | |
| Comparative | High | Non | Non | 2 | Non | Non | Non | 2 | 4 |
| Example 21 | | | | | | | | | |
| Comparative | High | Non | Non | 5 | Slightly | Non | Non | 4 | 9 |
| Example 22 | | | | | hard | | | | |
| Comparative | High | Non | Non | 5 | Slightly | Slightly | Slightly | 5 | 10 |
| Example 23 | | | | | hard | tender | firm | | |
| Comparative | Slightly | Slightly | Slightly | 7 | Hard | Slightly | Slightly | 6 | 13 |
| Example 24 | high | sticky | lustrous | | | tender | firm | | |
| Comparative | Slightly | Slightly | Slightly | 7 | Hard | Slightly | Slightly | 6 | 13 |
| Example 25 | high | sticky | lustrous | | | tender | firm | | |
| Comparative | Slightly | Slightly | Slightly | 7 | Hard | Slightly | Slightly | 6 | 13 |
| Example 26 | high | sticky | lustrous | | | tender | firm | | |
| Comparative | High | Non | Non | 3 | Non | Non | Non | 3 | 6 |
| Example 27 | | | | | | | | | |
| Comparative | High | Sticky | Non | 5 | Slightly | Non | Non | 3 | 8 |
| example 28 | | | | | hard | | | | |
| Comparative | Slightly | Sticky | Lustrous | 8 | Hard | Non | Non | 5 | 13 |
| Example 29 | high | | | | | | | | |
| Comparative | Low | Sticky | Lustrous | 9 | Hard | Slightly | Slightly | 6 | 15 |
| Example 30 | | | | | | tender | firm | | |
| Comparative | Low | Sticky | Lustrous | 9 | Hard | Slightly | Slightly | 6 | 15 |
| Example 31 | | | | | | tender | firm | | |
| Comparative | Low | Sticky | Lustrous | 8 | Hard | Slightly | Slightly | 6 | 14 |
| Example 32 | | | | | | tender | firm | | |
| Comparative | High | Non | Non | 0 | Non | Non | Non | 0 | 0 |
| Example 33 | | | | | | | | | |
| Comparative | High | Non | Non | 0 | Non | Non | Non | 0 | 0 |
| Example 34 | | | | | | | | | |
| Comparative | High | Non | Non | 1 | Non | Non | Non | 1 | 2 |
| example 35 | | | | | | | | | |
| Comparative | High | Non | Non | 0 | Non | Non | Non | 0 | 0 |
| Example 36 | | | | | | | | | |
| Comparative | High | Non | Non | 0 | Non | Non | Non | 0 | 0 |
| Example 37 | | | | | | | | | |
| Comparative | High | Non | Non | 1 | Non | Non | Non | 1 | 2 |
| Example 38 | | | | | | | | | |
| Comparative | High | Non | Non | 0 | Non | Non | Non | 0 | 0 |
| Example 39 | | | | | | | | | |
| Comparative | High | Non | Non | 0 | Non | Non | Non | 0 | 0 |
| Example 40 | | | | | | | | | |
| Comparative | High | Non | Non | 1 | Non | Non | Non | 1 | 2 |
| Example 41 | | | | | | | | | |
| Comparative | High | Non | Non | 3 | Slightly | Non | Non | 2 | 5 |
| Example 42 | | | | | hard | | | | |
| Comparative | High | Non | Non | 6 | Slightly | Slightly | Slightly | 5 | 11 |
| Example 43 | | | | | hard | tender | firm | | |
| Embodiment 3 | High | Slightly | Slightly | 7 | Hard | Tender | Firm | 8 | 15 |
| | | sticky | lustrous | | | | | | |
| Embodiment 4 | Slightly | Slightly | Slightly | 8 | Hard | Tender | Firm | 9 | 17 |
| | high | sticky | lustrous | | | | | | |
| Embodiment 5 | Slightly | Slightly | Slightly | 8 | Hard | Tender | Firm | 9 | 17 |
| | high | sticky | lustrous | | | | | | |
| Embodiment 6 | Slightly | Slightly | Slightly | 7 | Hard | Tender | Firm | 8 | 15 |
| | high | sticky | lustrous | | | | | | |

Tables 7 through 9 show the results for Samples saved for six, twelve and eighteen months. The frozen surimi ( Comparative examples 16 through 19, 22 through 25) obtained by adding saecharide and eighter one of basic amino acid or carbonate, in cases of frozen preservation of one, six and twelve months, these have results as near as the present invention, however in cases of frozen preservation of eighteen months, these have not the same results as the present invention.

In Tables 1 through 9, data for lysine hydrochloric acid salt is not shown, however, it was confirmed that such data are the same as data for arginine hydrochloric acid salt. Moreover, in Tables 1 through 9, data for sodium carbonate are not shown, it was confirmed that such data are the same as data for potassium carbonate.

Frozen surimi relating to the invention uses basic amino acids and carbonates as well as saccharides without using polyphosphates that have been conventionally used, so that various fish cakes produced from this fish paste as a basic ingredient are phosphorus-free, and therefore, fish cakes such as kamaboko, chikuwa, fish sausages that have no possibility of resulting in complaints of consumer groups can be produced. Furthermore, stable frozen storage equivalent to a case using polyphosphates is possible, and moreover, high-quality products can be realized.

1. Frozen surimi made from refined fresh meat subjected to water immersion and dehydration, containing (1) 0.05˜0.3% by weight of at least one kind selected among basic amino acids as food additives, (2) 0.05˜0.3% by weight of at least one kind selected among carbonates, and (3) at least one kind selected among saccharides.

2. The frozen surimi according to claim 1, wherein the content of saccharides is in a range between 5˜10% by weight.

3. The frozen surimi according to claim 1, wherein each of the content of basic amino acids and carbonates is in a range between 0.1%˜0.2% by weight, and the content of saccharides is in a range between 5%˜8% by weight.

4. The frozen surimi according to claim 1 wherein the basic amino acids are at least one selected among arginine, arginine hydrochloride base, lysine, and lysine hydrochloride base.

5. The frozen surimi according to claim 1 wherein the carbonates are at least one selected among sodium carbonate, potassium carbonate, calcium carbonate and sodium bicarbonate.
